(19) United States
(12) Patent Application Publication
(10) Pub. No.: US 2005/0133484 A1
(43) Pub. Date: Jun. 23, 2005

(54) Nozzle with a deflector for a plasma arc torch

(76) Inventor: Michel Delzenne, Franconville (FR)

Correspondence Address: Linda K. Russell;Air Liquide, Suite 1800, 2700 Post Oak Blvd., Houston, TX, 77056, US

(21) Appl. No.: 11/007,371

(22) Filed: Dec. 8, 2004

(30) Foreign Application Priority Data
Dec. 12, 2003 (FR) 0351043

(51) Int. Cl. B23K 9/00

(52) U.S. Cl. 219/121.5

(57) ABSTRACT

The invention relates to a nozzle (14) for a plasma torch, in particular a plasma cutting torch, the body of which has the general shape of an axisymmetric dish and includes an outlet orifice for the plasma gas jet, comprising a first external face (18) of circular shape and diameter d2, which includes, at its centre, the axial orifice for passage of the plasma jet, and an annular second external face (17), of outside diameter d3, which peripherally borders the first face (18), where d3>d2. According to the invention, the annular second external face (17) has an concave axisymmetric profile. Plasma cutting torch equipped with such a nozzle and its use in a plasma arc cutting operation.

The present invention relates to a nozzle with a deflector for a plasma cutting torch.

A plasma cutting torch generally comprises at least one nozzle for ejecting the plasma arc onto the workpiece to be cut, an electrode that forms the cathode, placed at a certain distance from the nozzle and coaxially therewith, means for supplying at least one plasma gas, generally chosen depending on the nature and the thickness of the material to be cut, and at least one means for delivering the plasma gas into the plasma chamber or volume that separates the electrode from the nozzle.

The cathode of the torch and the anode, which is formed by the workpiece to be cut, are connected to the negative and positive terminals, respectively, of a current generator.

During a cutting operation with a plasma torch, the latter is positioned in the immediate vicinity of the workpiece, a plasma arc is struck on the electrode of the torch in a suitable plasma gas medium, the arc is stretched out under the dust of the said plasma gas through the nozzle or nozzles via the central orifice of the latter and terminates on the workpiece where, owing to the thermal and kinetic characteristics of the plasma jet, it causes localized melting of the material forming the workpiece and ejects molten metal, thus forming a drillhole over the entire thickness, and then a cutting kerf is formed by relative displacement between the torch and the workpiece, which kerf determines, through the coordinated movements in the X and Y directions, the profile of the final part.

Several types of manual or automatic plasma torches are used in industry, namely those called single-flow torches and dual-flow torches. However, they all have as common characteristic an tip face that includes an ejection nozzle provided with a central orifice, opposite which nozzle the workpiece to be cut is placed, not far away and often perpendicular thereto.

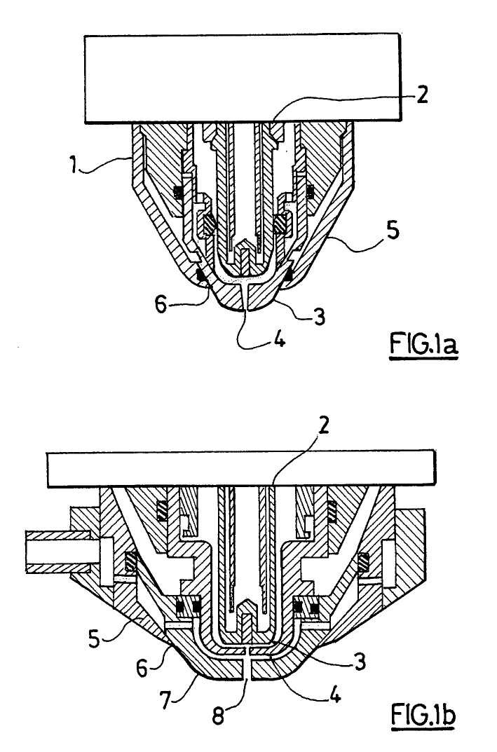

Thus, FIGS. 1a and 1b show, schematically, the tip face of two conventional torches, namely:

in FIG. 1, a torch 1, equipped for single-flow operation, which is provided with an electrode 2, with a nozzle 3 having a plasma jet outlet orifice 4, and with a shroud 5 for holding the nozzle 3 in the torch 1; and

in FIG. 1b, a torch 1, equipped for dual-flow operation, which is provided with an electrode 2, with a nozzle 3, which includes a plasma jet outlet orifice 4, and with a shroud 5 for holding the nozzle 3 in place in the torch 1; and

in FIG. 1b, a torch 1 equipped for dual-flow operation, which is provided with an electrode 2, with a first nozzle 3, which includes a plasma jet outlet orifice 4, with a second nozzle 7, which is held at a certain distance from and coaxially with the first nozzle 3 and includes a plasma jet outlet orifice 8, and with a shroud system 5 for holding the nozzles 3 and 7 in place in the torch 1.

In general, the plasma cutting nozzles used have, facing the workpiece, an tip of snub-nosed shape projecting beyond the retaining shroud, as illustrated by way of non-limiting example by the nozzle 3 in FIG. 1a and the nozzle 7 in FIG. 1b.

This shape most generally consists of a succession of connecting plane surfaces and of volumes of revolution, such as truncated cones having straight generatrices, which are sometimes joined to one another via fillets of rounded general shape.

Moreover, it is quite widespread practice for the nozzles to be locked in position, in a housing made at the tip of the torch body, via a terminal shroud fastened to the tip of the torch body, as shown schematically by the shrouds 5 in FIGS. 1a and 1b.

In addition, the outer profile of the shroud 5 and the outer profile of the nozzle 3, 7 usually form, in the region where they join, a change of slope, a shoulder or a profiled projection making a re-entrant angle, as shown by the angles 6 in FIGS. 1a and 1b, over the entire periphery of the tip of the torch nose.

However, in practice it turns out that these arrangements have a number of drawbacks.

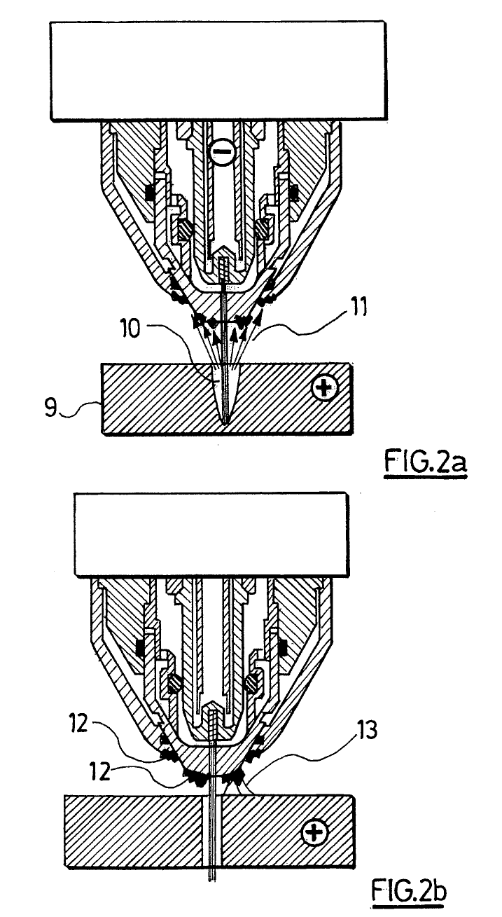

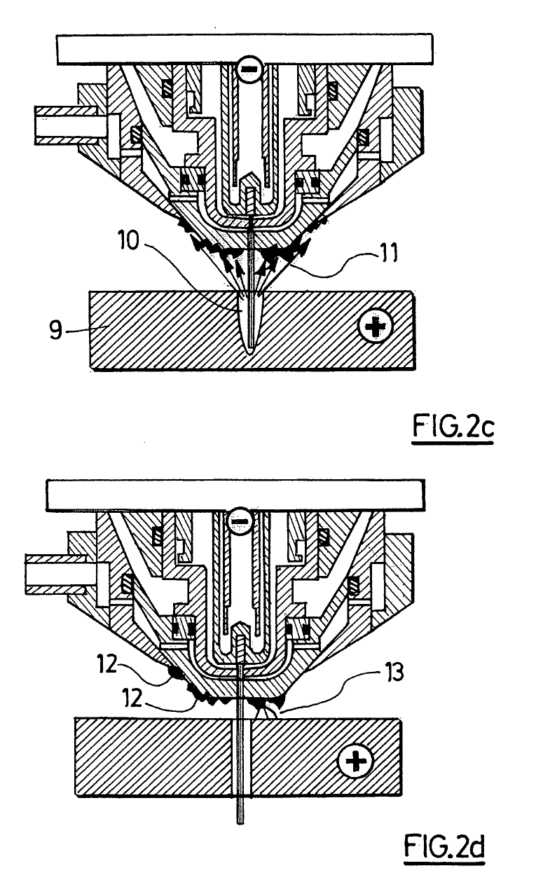

Thus, in the workpiece drilling phase, the front tip of the torch formed by the tip of the nozzle is brought close to the surface of the workpiece, and the plasma arc struck on the electrode of the torch terminates on the surface of the workpiece after the arc has passed through the ejection channel of the nozzle. The impact of the plasma jet on the workpiece then causes local melting of the constituent material of the workpiece, firstly surface melting and then, depending on the energy delivered by the plasma jet and on the thickness of the workpiece, deeper and deeper until the local melting fully emerges via the opposite face of the workpiece to be cut, as shown in FIGS. 2a to 2d, illustrating the torches of FIGS. 1a and 1b respectively, during a drilling operation and then a cutting operation.

During this phase, which may, depending on the energy of the plasma jet and the thickness to be drilled, require a time ranging from a few hundredths of a second to more than one second, the tip of the torch is subjected to intensive spattering with molten metal 11 erupting from the drilling crater 10 until the thickness of the workpiece 9 has been completely drilled through.

This therefore results in deposits of spattered and resolidified metal on the tip of the torch, as shown schematically in FIGS. 2b and 2d.

These deposits 12 form mainly at the re-entrant angle 6 connecting the shroud to the nozzle and on the snub-nosed tip part of the nozzles 3, 7.

The deposits 12, in the re-entrant angle 6 not only damage the shroud but also become fixed at the point of connection with the shroud. This may prevent or impede the removal of the shroud, during an operation to replace the nozzle, it may compromise the seal needed between shroud and nozzle, in order to prevent the leakage of cooling water or gas, depending on the case, and it may prevent the shroud from being reassembled correctly on the nozzle, after the maintenance operation.

This generally leads to shrouds and nozzles being replaced more frequently in order to resume correct operation.

Furthermore, since the deposits 12 on the tip of the nozzle 3, 7 project from the normal tip profile of the said nozzle 3, 7, they further reduce the actual distance separating the nozzle from the workpiece and do not fail to cause, during the drilling phase or subsequently during the cutting phase, problems of:
formation of double arcs 13 (cf. FIG. 2b and FIG. 2d) between the excrescences formed by these metal deposits 12 and the workpiece 9, which rapidly result in damage to the channel outlet geometry of the nozzle 3, 7 and therefore cause the cutting performance to deteriorate; and/or
direct electrical contacting of the excrescences of the metal deposits 12, and therefore of the nozzle 3, 7, with the workpiece 9, the consequence of which is serious damage or even destruction of the said nozzle 3, 7 because it is brought to the electrical potential of the workpiece. Here again, the cutting performance will be dramatically reduced.

The problem to be solved is therefore to propose a plasma torch nozzle that does not have the problems and drawbacks mentioned above, that is to say in particular to propose a nozzle that has a longer lifetime than the conventional nozzles, when used under the same operating conditions, so as to allow a larger number of drillholes to be produced than with the nozzles of the prior art, without appreciable accumulation at its tip with metal expelled from the drilling crater, nor formation of a double arc prejudicial to correct execution of the cutting operations.

The solution of the invention is therefore a nozzle for a plasma torch, in particular a plasma cutting torch the body of which has the general shape of an axisymmetric dish and includes an outlet orifice for the plasma gas jet, comprising a first external face of circular shape and diameter d2, which includes, at its centre, the axial orifice for passage of the plasma jet, and an annular second external face, of outside diameter d3, which peripherally borders the first face, where d3>d2, characterized in that the said annular second external face has a concave axisymmetric profile.

Depending on the case, the nozzle of the invention may include one or more of the following technical features:
the said annular second external face has a concave axisymmetric profile forming a deflector for the high-temperature metal particles;
the first face of circular shape and the annular second face join together at an external peripheral edge of diameter d2;
the ratio of the diameter d1 of the plasma gas jet outlet orifice to the diameter d2 of the first face is such that 1.5<d2/d1<5, preferably such that 2<d2/d1<3;
the concave profile of the annular second face is formed by at least one circular arc, at least one portion of an ellipse, at least one portion of a hyperbola, at least one portion of a parabola or any other continuous curvilinear segment;
the concave profile of the annular second face has a width L measured at a point A located on the edge of outside diameter d3 of the annular second face, has a point B located on the edge of diameter d2 of the second face and has a concavity depth F between the second face and a straight line joining the said points A and B, such that:
   F>0 and 0.01 L<F<0.23 L;
the angle α made by the axis of symmetry of the body of the nozzle and the straight line passing through the points A and B is chosen such that: α<90°, preferably α<80°;
the angle β made by the axis of symmetry of the body of the nozzle and the tangent to the curve of the profile at the point of intersection between the profile and the edge of diameter d3 is chosen such that β≧90°;
the distance h separating the point A from the point C closest to the profile of the shroud is chosen such that h≧0; and
the surface of the first nozzle tip face and the surface of the annular second face have a roughness such that Ra≦1.6 μm, preferably Ra≦0.8 μm.

The invention also relates to a plasma cutting torch comprising a nozzle according to the invention, and also to the use of such a nozzle or of such a torch in a plasma arc cutting operation.

Expressed in another way, the inventor of the present invention has shown that, by modifying the tip geometry of the plasma jet ejection nozzle, the above-mentioned drawbacks have been virtually eliminated.

The proposed geometry within the context of the invention is advantageously applicable to any plasma cutting nozzle, whatever the use thereof, namely manual or automatic cutting, whatever the applications thereof, namely the cutting of structural steels, stainless steels, aluminium alloys or any other material that can be cut by a plasma cutting process, whatever the plasma-generating fluid, i.e. liquid, gas or gas mixtures, whether oxidizing or non-oxidizing, inert or chemically active, for example a reducing agent, and whatever the power of the plasma jet.

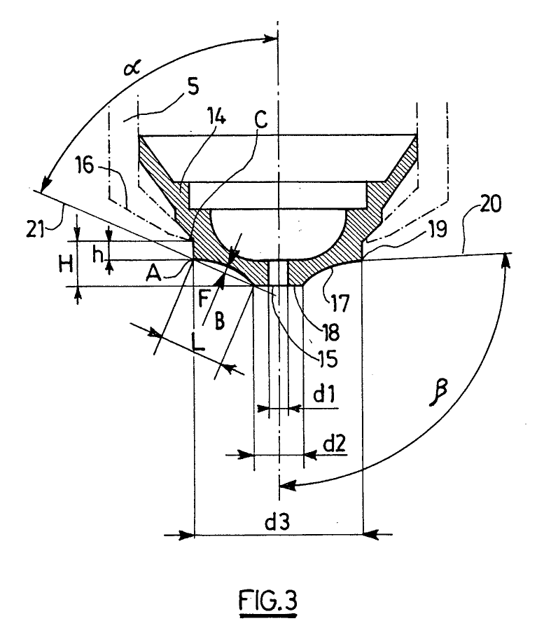

FIG. 3 shows an example of a nozzle 14 according to the invention intended to be held coaxially in a retaining shroud 5 and locked in position in a torch body (not shown).

The retaining shroud 5 has an tip profile 16 of frustoconical general shape and the nozzle 14 has a tip, of snub-nosed general shape, projecting axially from the shroud 5 by a distance H.

According to the invention, the snub-nosed tip of the nozzle 14 is provided, going from its diameter d2 to its diameter d3, with an intermediate connecting surface 17 of axisymmetric concave profile forming a deflector for the high-temperature metal particles, that is to say particles at a temperature close to the melting point of their constituent material, emanating from the workpiece during the drilling operation, as described above.

To obtain an optimum hot-particle deflection effect while maintaining satisfactory thermal resistance of the nozzle 14 near the plasma jet passing through the latter via the orifice 15 of diameter d1, a number of arrangements must preferably be respected, namely that:
the diameter d2 is chosen relative to the nozzle orifice diameter d1 in such a way that the front face 18 is of small enough area to pick up only a minimum amount of hot particles emanating from the workpiece but large enough not to cause heat concentration, arising from the vicinity of the plasma jet, in the outlet region of the orifice 15 of diameter d1. Consequently, it is advantageous to choose the ratio of the two diameters d1 and d2 in such a way that: 1.5<d2/d1<5, preferably the ratio is such that 2<d2/d1<3;
the axisymmetric concave profile 17, formed by way of non-limiting example from one or more circular arcs, a portion of an ellipse, a portion of a hyperbola, a portion of a parabola or any other continuous curvilinear segment, characterized by the dimension L corresponding to the width L of the said profile made at a point A, resulting from the intersection of the diameter d3 with the profile 17, has a point B, resulting from the intersection of the face 18 of diameter d2 with the said profile 17, and characterized by the dimension F corresponding to the depth F of the concavity, is chosen so that the value of F satisfies the relationships:
   F>0 and 0.01 L<F<0.23 L;
the angle α made by the axis of symmetry of the nozzle 14 and the straight line 21 passing through the points A and B is chosen such that: α<90°, preferably α<80°;
the angle β made by the axis of symmetry of the nozzle 14 and the tangent 20 to the curve of the profile 17 at the point of intersection 19 between the profile 17 and the diameter d3 is chosen such that β≧90°;
the distance h separating the point A, in other words the circular edge resulting from the intersection between the profile 17 and the diameter d3, from the point C closest to the profile 16 of the shroud 5 is chosen such that: h≧0; and
the nozzle tip face 18 and that face defined by the profile 17 have a roughness such that: Ra≦1.6 μm and preferably Ra≦0.8 μm, Ra being the arithmetic mean roughness (AMR) according to the ISO 4287 standard.

The nozzles produced according to the present invention and used instead of the nozzles of the prior art in plasma cutting torches, under standard operating conditions, make it possible to drill a larger number of holes, about 10 to 20 times more, than with the nozzles of the prior art without appreciable accumulation of metal expelled from the drilling crater near their tip, nor formation of a double arc prejudicial to correct execution of the cutting operations.

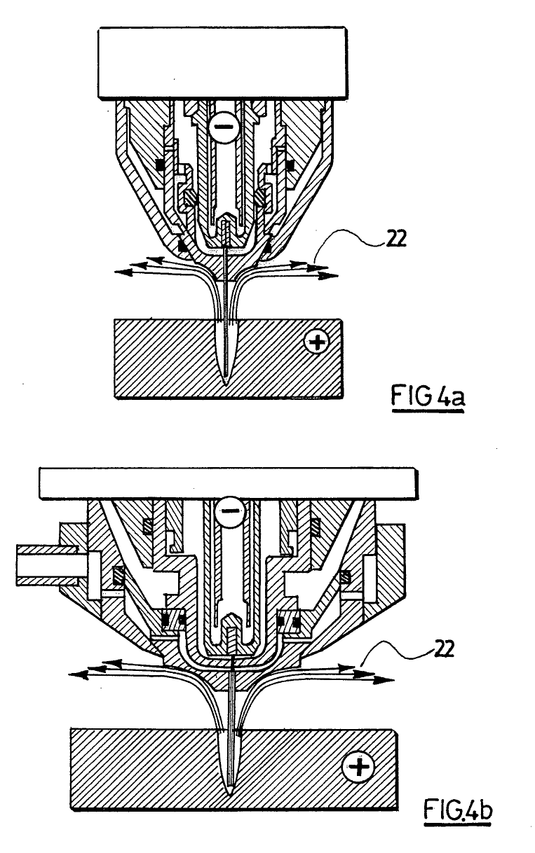

This spectacular effect is illustrated by FIGS. 4a and 4b, which show schematically the way in which the paths of the high-temperature metal particles 22 are deflected by the nozzle profiles according to the present invention.

By way of non-limiting example, the table below gives tip dimensions for a few nozzles in accordance with the present invention, which result in a large number of drillholes, i.e. 10 to 20 times more than with a nozzle according to the prior art, with neither damage nor loss of cutting performance.

TABLE 1

| | | | Gas | | | | | | | | | |
|---|---|---|---|---|---|---|---|---|---|---|---|---|
| | | | flow | | | | | | | | | |
| | | Plasma gas | rate | | | | | | | | | |
| | I_{c} | (vol %) | (l/min) | d1 | d2 | d3 | L | F | d2/d1 | F/L | α | β |
| Single- | 40 A | O₂ | 4.6 | 0.9 | 2 | 18.4 | 8.92 | 0.479 | 2.22 | 0.054 | 67° | >90° |
| flow | 2 A | O₂ | 3 | 0.65 | 1.5 | 18.4 | 9.15 | 0.503 | 2.30 | 0.055 | 67° | >90° |
| torch | | | | | | | | | | | | |
| nozzles | | | | | | | | | | | | |
| Dual- | 120 A | N₂ + 8.3% CH₄ + 6.4% O₂ | 43 | 2.9 | 5.72 | 20 | 7.95 | 0.708 | 1.97 | 0.089 | 67° | 90° |
| flow | 120 A | N₂ + 40% O₂ | 45 | 2.5 | 7.4 | 22.6 | 8.37 | 0.424 | 2.96 | 0.051 | 79° | 90° |
| torch | | | | | | | | | | | | |
| nozzles | | | | | | | | | | | | |

1-12. (canceled)

13. A nozzle for a plasma torch, the body of which has the general shape of an axisymmetric dish and includes an outlet orifice for the plasma gas jet, comprising:
a) a first external face, said first external face further comprising a circular shape of diameter d2, and a central axial orifice for passage of the plasma gas jet of diameter d1; and
b) an annular second external face, said second external face further comprising a concave axisymmetric profile, an outside diameter d3, peripherally bordering said first external face, and d3>d2.

14. The nozzle of claim 13, wherein said annular second external face has a concave axisymmetric profile forming a deflector for high-temperature metal particles.

15. The nozzle of claim 13, wherein said first external face and said annular second external face join together at an external peripheral edge of diameter d2.

16. The nozzle of claim 13, wherein 1.5<d2/d1<5.

17. The nozzle of claim 13, wherein 2<d2/d1<3.

18. The nozzle of claim 13, wherein the concave profile of said annular second face is formed by at least one curvilinear segment selected from the group consisting of a circular arc, at least one portion of an ellipse, at least one portion of a hyperbola, at least one portion of a parabola, or any other continuous curvilinear segment.

19. The nozzle of claim 13, wherein the concave profile of said annular second face further comprises
a) a width L measured at a point A located on the edge of outside diameter d3 of the annular second face,
b) a point B located on the edge of diameter d2 of the second face, and
c) a concavity depth F between the second face and a straight line joining the said points A and B, such that F>0 and 0.01 L<F<0.23 L.

20. The nozzle of claim 19, wherein the angle α made by the axis of symmetry of the body of the nozzle and the straight line passing through the points A and B is chosen such that α<90°.

21. The nozzle of claim 19, wherein the angle α made by the axis of symmetry of the body of the nozzle and the straight line passing through the points A and B is chosen such that a<80°.

22. The nozzle of claim 13, wherein the angle β made by the axis of symmetry of the body of the nozzle and the tangent to the curve of the profile at the point of intersection between the profile and the edge of diameter d3 is chosen such that β≧90°.

23. The nozzle of claim 19, wherein the distance h separating said point A from a point C closest to the profile of the shroud is chosen such that h≧0.

24. The nozzle of claim 13, wherein the surface of said first external face and the surface of said annular second external face have a roughness (Ra) such that Ra≦1.6 μm.

25. The nozzle of claim 13, wherein the surface of said first external face and the surface of said annular second external face have a roughness (Ra) such that Ra≦0.8 μm.

26. A plasma cutting torch, comprising a nozzle of claim 13.

27. The method of using a nozzle of claim 13 in a plasma arc cutting operation.

28. The method of using a torch of claim 26 in a plasma arc cutting operation.
